(19) United States
(12) Patent Application Publication
(10) Pub. No.: US 2007/0133063 A1
(43) Pub. Date: Jun. 14, 2007

(54) System and method for document tracking and security

(75) Inventor: Steven J. Harrington, Webster, NY (US)

Correspondence Address: BASCH & NICKERSON LLP, 1777 PENFIELD ROAD, PENFIELD, NY, 14526, US

(73) Assignee: Xerox Corporation, Stamford, CT (US)

(21) Appl. No.: 11/301,379

(22) Filed: Dec. 13, 2005

(51) Int. Cl. H04N 1/00

(52) U.S. Cl. 358/403

(57) ABSTRACT

A document history device is communicatively connected with a document repository, a viewing station, a scanning station, a printing station, or a distribution device, each including a document history agent. The document history agent conveys information associated with a particular document so that the document history device can create a comprehensive history for the document wherein the history can provide information relating to how many document instances have been generated, how many document instances are currently active, who currently has access to the document instances, what would need to be done to completely destroy the document and all document instances, how recently has the document been accessed and by whom, who is a frequent source of information, which documents are most useful, what is the typical document lifetime, and/or what classes of documents does a particular user or class of users view.

### BACKGROUND

For many documents, it is difficult to determine where the document came from or how many copies of the document exist. However, for sensitive documents, it is desirable to control and track the access and/or generation of the document.

A document is defined as a unique assembly of information collected normally for human consumption. A document may be stored in one or more electronic files and printed on one or more paper pages. Copies of the document can be in an electronic form or hardcopy form. Each copy may be referred to as a document instance.

It is further noted that when the information within a document is altered, the altered document may be considered a revision of the original document. However, it is possible to treat document revisions as new documents with links back to their originating instance or the revisions are treated as further instances of an original document.

One conventional method of tracking a document was to print a unique identifier, in the background, on each document instance. If the document was photocopied, the identifier could indicate the source of the copy.

Other technologies, such as glyphs, have also been used to track hardcopies of a document. More specifically, data glyphs can be added to a document when printing or copying. These data glyphs would describe the event of printing or copying. The glyph data could then be recovered when scanning and added to the electronic version of the document, along with information about the scanning event.

While these conventional tracking methods can provide information with respect to where a document came from, these conventional tracking methods have not necessarily been able to provide information with respect to how many copies of a document have been made and who has copies of the document.

Conventional document management systems can also track certain document events. Moreover, these conventional document management systems can determine when a document is checked out, modified, and/or checked in. However, these conventional document management systems have been primarily designed to control document modifications.

Although conventional systems are capable of tracking a source of a document, these conventional systems do not necessarily retain information about a document and each of its instances. Moreover, these conventional systems do not necessarily record when a document is created, when an instance is generated, and when and where instances are distributed.

Thus, it is desirable to retain information about a document and each of its instances. Furthermore, it is desirable to record when a document is created, when an instance is generated, and when and where instances are distributed.

### BRIEF DESCRIPTION OF THE DRAWINGS

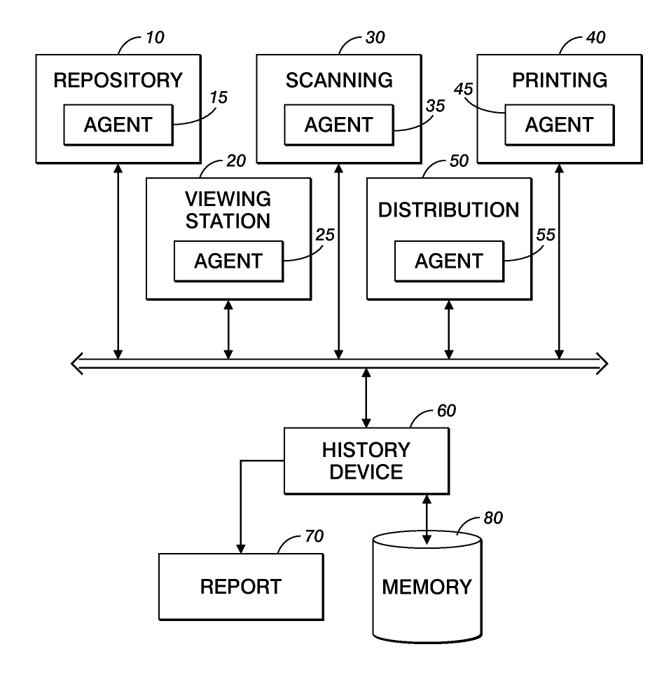

The drawings are only for purposes of illustrating embodiments and are not to be construed as limiting, wherein FIG. 1 is a block diagram illustrating a system for document tracking and recording.

### DETAILED DESCRIPTION

For a general understanding, reference is made to the drawings. In the drawings, like references have been used throughout to designate identical or equivalent elements. It is also noted that the drawings may have been drawn not to scale and that certain regions may have been purposely drawn disproportionately so that the features and concepts could be properly illustrated.

In a secure environment, electronic and physical boundaries control the domain of a document. Thus, the operations upon a document can be limited and controlled.

For example, the printing of documents of document instances could be limited to only printing devices that will report the printing action to an information collection agent. Such an agent would be particularly useful in an environment were all document copying and distribution functions report their actions.

However, it is also desirable to track and record the history of a document in a non-secure environment. More specifically, as noted above, it is desirable to record when a document is created or viewed, when an instance is generated or viewed, and when and where instances are distributed or viewed in a non-secure environment.

In FIG. 1, a system for document tracking and recording includes a document history device 60. The document history device 60 is communicatively connected with various devices that interact with the documents to be monitored and tracked. The document history device 60 may be a server, a personal computing device or work station, or other such computing device.

As illustrated in FIG. 1, the document history device 60, for example, may be communicatively connected with a plurality of document event devices. Examples of document event devices are a document repository 10, a viewing station 20 (such as a personal computing device, personal digital assistance, work station, or other such device capable of retrieving documents and displaying the contents thereof), a scanning station 30, a printing station 40, or a distribution device 50 (such as an e-mail agent, fax agent, or other such agent capable of distributing an electronic version of document).

The document repository 10, viewing station 20, scanning station 30, printing station 40, or distribution device 50, each includes a document history agent. More specifically, the document repository 10 includes a repository document history agent 15; the viewing station 20 includes a viewing document history agent 25; a scanning station 30 includes a scanning document history agent 35; a printing station 40 includes a printing document history agent 45; and a distribution device 50 includes a distribution document history agent 55.

With respect to the repository document history agent 15, the repository document history agent 15 communicates, to the document history device 60, information relating to document access, document creation, document modification, etc. This information is used by the document history device 60 to create and maintain a comprehensive history of the document.

For example, the information communicated by the repository document history agent 15 may include creation information relating to when the original document was created and by whom. The information communicated by the repository document history agent 15 may also include retrieval information relating to when was this document retrieved. Furthermore, the information communicated by the repository document history agent 15 may include document instance generation information relating to the number of copies of the document that have been generated. Moreover, the information communicated by the repository document history agent 15 may include usage information relating to the purpose and/or context in which the document is being retrieved. The information communicated by the repository document history agent 15 may include access information relating to who has retrieved the document. In addition, the information communicated by the repository document history agent 15 may include revision information. The information communicated by the repository document history agent 15 may also include encryption and/or decryption information.

With respect to the viewing document history agent 25, the viewing document history agent 25 communicates, to the document history device 60, information relating to document access, document creation, document modification, document distribution, etc. This information is used by the document history device 60 to create and maintain a comprehensive history of the document.

For example, since a viewing station may be a personal computing device, the information communicated by the viewing document history agent 25 may include creation information relating to when the original document was created and by whom. The information communicated by the viewing document history agent 25 may also include retrieval information relating to when the document was retrieved from the viewing station or other remote device. Moreover, the information communicated by the viewing document history agent 25 may include usage information relating to the purpose and/or context in which the document is being retrieved/viewed. Furthermore, the information communicated by the viewing document history agent 25 may include access information relating to who has retrieved/viewed the document. In addition, the information communicated by the viewing document history agent 25 may include revision information. The information communicated by the viewing document history agent 25 may also include encryption and/or decryption information.

With respect to the scanning document history agent 35, the repository document history agent 35 communicates, to the document history device 60, information relating to the document being scanned. This information is used by the document history device 60 to create and maintain a comprehensive history of the document.

For example, the information communicated by the scanning document history agent 35 may include document identification information. The information communicated by the scanning document history agent 35 may also include scanning information relating to when this document was scanned. Furthermore, the information communicated by the scanning document history agent 35 may include document instance generation information relating to the number of copies of the document that have been scanned. Moreover, the information communicated by the scanning document history agent 35 may include destination information relating to the forwarding destination of the scanned electronic document.

With respect to the printing document history agent 45, the printing document history agent 45 communicates, to the document history device 60, information relating to document reproduction. This information is used by the document history device 60 to create and maintain a comprehensive history of the document.

For example, the information communicated by the printing document history agent 45 may include information relating to what document was printed and by whom. It is noted that the printing of the document may include the printing of identification information, such as data glyphs, in the reproduced document to be used in future tracking and monitoring. The information communicated by the printing document history agent 45 may also include information relating to the number of copies of the document that have been reproduced.

With respect to the distribution document history agent 55, the distribution document history agent 55 communicates, to the document history device 60, information relating to document access, document creation, document dissemination, etc. This information is used by the document history device 60 to create and maintain a comprehensive history of the document.

For example, the information communicated by the distribution document history agent 55 may include retrieval information relating to when the document was retrieved for dissemination. Furthermore, the information communicated by the distribution document history agent 55 may include document instance information relating to the number of copies of the document that have been disseminated. Moreover, the information communicated by the distribution document history agent 55 may include usage history relating to the purpose and/or context in which the document is being disseminated. The information communicated by the distribution document history agent 55 may include dissemination information relating to who is receiving the document. The information communicated by the distribution document history agent 55 may also include encryption and/or decryption information.

Upon receiving the various types of information described above, the document history device 60 processes the information and creates a comprehensive history of each monitored document. The history can be stored in a memory device 80, such as a server or other accessible electronic read/writable memory. Moreover, the document history device 60 can generate reports 70 relating to various aspects of a document's history.

The comprehensive history created by the document history device 60 may include document identification information, preferably, a unique identified for each unique document; document information such as author identification, revision history, revision author identification, creation time/date, and/or revision date; information relating to document instances such as document instance identification information, document instance creation time/date, document instance creation source, document instance creation authority, document instance creation mechanism, document instance creation media, and/or document instance creation format; and information relating to encryption and/or decryption.

The document history device 60 may also generate a report relating to a history of events for a document, a report relating to summary statistics for a document, a report relating to user authentication, and/or a report relating to encryption and/or decryption.

The document history device 60 may be implemented utilizing a computer system including a processor, an input device, an output device, and persistent media storage.

Additional information may be received by the document history device 60 such as an instance identifier, who is controlling the document instance, and what device is providing the access or instance generation. This information can be by the document history device 60 so that the document history device 60 can determine how a document instance was created; e.g., from which document instance it was copied.

As noted above if printing, copying and scanning of the document instance is to be permitted, recording of the instance information should be recorded on the document. The instance information can be recorded via data glyphs or by other mechanisms for encoding data in documents such as digital watermarks or the use yellow dots in the background.

In addition to recording the instance when printing (so that it can be read when scanning), the peripheral devices or the drivers thereof should record the generation of a new document instance. It is noted that the use of a document history device can simplify the recording of information within the document instance itself, since the document instance need only contain its unique identifier. The unique identifier can then be used to acquire more detailed information about the instance from the document history device.

The document history device can be used to provide an audit trail for a particular document instance that could include items such as how many document instances have been generated, how many document instances are currently active, who currently has access to the document instances, what would need to be done to completely destroy the document and all document instances, how recently has the document been accessed and by whom. The document history device also provides the opportunity to data-mine many documents to answer questions such as who is a frequent source of information, which documents are most useful, what is the typical document lifetime, and what classes of documents does a particular user or class of users view.

In operation, when one of the various devices (10, 20, 30, 40, and 50) encounters a document instruction, an agent associated with the device communicates the appropriate information the document history device 60. It is noted that the agent may be a software application and/or hardware that resides within the device or associated therewith.

For example, if the printing device 40 receives an instruction to reproduce document A, the printing device agent 45 sends information to the document history device 60. The information may correspond to the identification of the document to be reproduced, identification of the requester, and number of copies. The document history device 60 uses this information to update the comprehensive history of document A.

In summary, agents are utilized to inform a document history device as to the nature of events associated with a particular document so that the document history device can create a comprehensive history for the document wherein the history can provide information relating to how many document instances have been generated, how many document instances are currently active, who currently has access to the document instances, what would need to be done to completely destroy the document and all document instances, how recently has the document been accessed and by whom, who is a frequent source of information, which documents are most useful, what is the typical document lifetime, and/or what classes of documents does a particular user or class of users view.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system for monitoring a document to produce a history associated with the document, comprising:
a document event device; and
a document history device communicatively connected to said document event device;
said document event device including a document history agent;
said document history agent communicating to said document history device information relating to a document event corresponding to a particular document and associated with said document event device;
said document history device creating a history associated with the particular document.

2. The system as claimed in claim 1, wherein said document event device is a document reproduction device.

3. The system as claimed in claim 1, wherein said document event device is a document scanning device.

4. The system as claimed in claim 1, wherein said document event device is an electronic dissemination device.

5. The system as claimed in claim 1, wherein said document event device is a document repository.

6. The system as claimed in claim 1, wherein said document event device is a document viewing device.

7. The system as claimed in claim 1, wherein said document history agent communicates to said document history device a number of document instances associated with the document event.

8. The system as claimed in claim 1, wherein said document history agent communicates to said document history device information pertaining to who access the particular document during the document event.

9. The system as claimed in claim 1, wherein said document history agent communicates to said document history device information pertaining to a dissemination destination of the particular document.

10. The system as claimed in claim 1, wherein said document history device determines how many document instances of the particular document have been generated.

11. The system as claimed in claim 1, wherein said document history device determines how many document instances of the particular document are currently active.

12. The system as claimed in claim 1, wherein said document history device determines who currently has access to document instances of the particular document.

13. The system as claimed in claim 1, wherein said document history device determines a course of action for completely destroying the particular document and all document instances thereof.

14. The system as claimed in claim 1, wherein said document history device determines how recently has the particular document been accessed and by whom.

15. The system as claimed in claim 1, wherein said document history device determines if the particular document is useful.

16. The system as claimed in claim 1, wherein said document history device determines a lifetime of a typical document.

17. The system as claimed in claim 1, wherein said document history device determines what classes of documents does a particular user or class of users view.
